(19) United States
(12) Patent Application Publication
(10) Pub. No.: US 2026/0229472 A1
(43) Pub. Date: Aug. 6, 2026

(54) ION SIGNAL OPTIMISATION

(71) Applicant: Thermo Fisher Scientific (Bremen) GmbH, Bremen (DE)

(72) Inventors: Norbert Quaas, Bremen (DE); Hans-Jürgen Schlüter, Bremen (DE); Benno Strasser, Bremen (DE)

(73) Assignee: Thermo Fisher Scientific (Bremen) GmbH, Bremen (DE)

(21) Appl. No.: 19/149,288

(22) PCT Filed: Feb. 9, 2024
(86) PCT No.: PCT/EP2024/053339

§ 371 Date: Jul. 18, 2025

(30) Foreign Application Priority Data
Feb. 9, 2023 (GB) 2301822.9

(51) Int. Cl. H01J 49/00; G01N 30/72; H01J 49/06

(52) U.S. Cl. CPC H01J 49/0031; G01N 30/724; H01J 49/0009; H01J 49/067

(57) ABSTRACT

Methods and systems for calibrating a mass spectrometer having one or more ion lenses and a mass analyser comprise acquiring from the mass analyser a plurality of mass spectra from a sample comprising a plurality of ion masses. A voltage value applied to the one or more ion lenses is static while each mass spectrum is obtained and the voltage value is varied between different mass spectra. A voltage value providing an optimum ion signal for each of the plurality of ion masses in the sample is determined from the plurality of mass spectra and corresponding voltages applied to the one or more ion lenses during acquisition of each mass spectrum. Data indicating the ion mass value and corresponding voltage value providing the optimum ion signal for each of the plurality of ion masses in the sample are stored.

### FIELD OF THE INVENTION

The present invention relates to a system and method for calibrating and operating a mass spectrometer to provide optimum ion signals.

### BACKGROUND OF THE INVENTION

There are various optimisation techniques that are used to tune the transmission of ion optical systems and especially for mass spectrometers. A set of ion lens voltage settings may be chosen according to the results of such optimisation procedures. However, these techniques can only optimise for a single ion species, i.e., for a specific m/z ratio. Other ions with different m/z will be transmitted through the ion optical system but are likely to encounter aberrations and inefficiencies due to the characteristics of the ion lens system and beam properties, such as its energy distribution and diameter.

The optimisation procedure may consider more than one ion signal when determining a lens voltage to be applied. A compromise may be achieved to allow for a balanced transmission of the lens system across different ion masses across a target m/z range. However, optimum transmission cannot be reached, because for every individual ion lens, there will be losses due to systematic dependences e. g., between the mass and the kinetic energy of ions.

Typically, a static voltage setting is applied, which is a compromise that will suppress ions at the opposite ends of the m/z range, while transmission of mid-range ions can be close to or at a maximum signal. A tuning method that balances the intensities of several ion signals simultaneously can better deal with this effect, but it does not change the fundamental variation of transmission across a range of m/z.

FIG. 1 illustrates to results of such a comprise auto-tune technique obtained from an iCAP™ Qnova instrument. Two different ions of very different m/z are shown in the graph of FIG. 1 (7-Li and 238-U). The auto-tune procedure is to vary an ion lens voltage applied to a particular ion lens in the mass spectrometer (y-axis). The transmission maxima of the two different m/z ions do not coincide for any particular voltage, which is largely caused by the inherent dependence between ion mass and ion kinetic energy. The vertical arrow indicates a voltage (around −85 V) where a compromise ion lens voltage is selected. At this compromise lens voltage, the transmission of 238U is around 20% below its optimum signal, but this provides an acceptable signal across the majority of the m/z range.

Dealing with image aberrations is a well-known problem in particle optics as well as in light optics. There are many published and proven approaches to reduce aberration effects in flat field imaging. Traditionally, attempts to correct for aberrations are based on adding corrective optical elements to a lens stack. One example is the hexapole corrector in Transmission Electron Microscopy [Rose 1990; Haider 1995], another is the apochromatic correction of light optics by matching complementary pairs of lenses, which is used in many consumer products today, see for example [Sasian 2017] and references therein.

Another method used in light optics tailors the phase information for image correction in a flat optical lens design, which is making use of nanostructured flat optical surfaces [Li 2021].

Other than in flat-field imaging, systems that only require an optimised point-to-point image are much simpler to correct by using beam shaping and transport optics. The energy correction in these systems needs to work for one single position only. In the case of ion beams, the restrictions imposed by the laws of electrostatics are more difficult to overcome than in light optics. Therefore, a possible solution could involve aspherical ion lenses, by introducing 3D-shaped grids. However, apart from significant difficulties in manufacturing such devices, transmission losses remain unavoidable.

A further problem, that specifically occurs in elemental mass spectrometry, is the m/z-dependent transmission of ions in electrostatic beam transport systems. In inductively coupled plasma mass spectrometry (ICP-MS), the separation of neutrals and ions in the first stage of a mass spectrometer often is achieved by non-axial lens arrangements. Wide electrostatic apertures and deflection elements are common technologies that ensure high transmission and simultaneously avoid contamination of surfaces. Aberration effects are mainly due to the dependence of the kinetic energy of ions on m/z. This is comparable to chromatic aberrations in light optics.

Therefore, there is required a method and system that overcome these problems.

### SUMMARY OF THE INVENTION

The ion signals obtained from a mass spectrometer are optimised by carrying out a calibration or tuning procedure before sample data are collected. One or more test samples are used to provide a plurality of ion masses. Therefore, several m/z values are used in the calibration procedure.

The mass spectrometer includes one or more ion lenses used to focus and/or guide ions. These ion lenses use voltages to generate electric fields that influence an ion beam. The voltage applied to each ion lens affects the ion signal for each ion that is measured by the detector of the mass spectrometer. However, changing the voltage applied to an ion lens or ion lenses has a different effect on the ion signals from different ions having different m/z.

A mass spectrum is generated for different ions (having different m/z values) of the calibration sample or calibration samples. A full set of ion signals is obtained for all ion masses (e.g., 1, 2, 3, 4, 5 or more ion masses) with the voltage or voltages applied to the one or more ion lenses of the mass spectrometer left unchanged or static between the collection of ion signals for different ions (m/z). Different voltages may be applied to different ion lenses, but the voltage applied to each ion lens is held constant across the mass range of ions. The mass spectrum (or at least portions of the mass spectrum around each m/z) is stored.

One or more of the voltages (e.g., DC, AC, RF, or in any combination) applied to one or more of the ion lenses is varied and a mass spectrum is again acquired for different ions (m/z) of the calibration sample or calibration samples. A full set of ion signals is obtained for more than one ion mass (or all ion masses) with the voltage or voltages applied to the one or more ion lenses of the mass spectrometer left unchanged or static between the collection of ion signals for different ions (m/z) at this new voltage. Again, the data are stored and the process is repeated for further different voltages.

Using the collected data (different mass spectra collected when different voltages are applied to one or more of the ion lenses) for each ion mass or m/z value, an optimised voltage applied to one or more of the ion lenses is determined. The optimised voltage setting may be the voltage or voltages applied to the ion lens or lenses when a particular ion signal is generated exhibiting its highest ion signal, its signal having the highest signal to noise ratio, or an ion signal optimised in another way. Typically, the optimised voltage that provides the best or optimised ion signal for a particular ion lens and ion mass (m/z) will be different for each ion mass (m/z). This optimised voltage (and corresponding ion lens indicator) is recorded or stored for each ion mass. Therefore, a set (for each ion lens) of preferred, tuned or optimised voltages is generated or stored against several ion masses (m/z). This set of results may form the calibration data. Several sets of results may be recorded (one for each ion lens in the mass spectrometer).

When a mass spectrum of an analyte or test sample is acquired (having one or more different constitute ions) then the voltage or voltages applied to the ion lens or lenses is/are set to the optimised value for each ion mass or m/z for those particular ion lenses. For a test sample having a single ion species, the voltage applied to the ion lens or ion lenses is determined based on the previously acquired calibration data. If the test sample contains more than one ion mass (m/z), then as the ion signal for each ion species is acquired, the voltage applied to the ion lens or ion lenses is changed so that an optimised ion signal is obtained for each ion species. For example, if the calibration data indicates that an optimised ion signal can be obtained for a 7Li ion when a particular ion lens has a voltage of −100 V applied and the calibration data indicate that an optimised ion signal can be obtained for a 238U ion when a particular ion lens has a voltage of −130 V applied, then these are the voltages applied (and changed) to the ion lens when the mass spectrometer is acquiring ion signals from these ion species. In other words, the voltage applied to the one or more ion lenses across the range of detected ion masses (m/z) is varied for each m/z so that optimised ion signals are provided at each value rather than a comprise value that only optimises one (or none) of the ion signals.

As well as a DC voltage applied to the ion lens or ion lenses, RF or AC signals may also be applied.

Against this background and in accordance with a first aspect there is provided a method for calibrating a mass spectrometer having one or more ion lenses and a mass analyser, the method comprising the steps of:
acquiring from the mass analyser a plurality of mass spectra from a sample, the sample comprising a plurality of ion masses, wherein a voltage value applied to the one or more ion lenses is static while each mass spectrum is obtained and the voltage value is varied between different mass spectra;
determining from the plurality of mass spectra and corresponding voltage applied to the one or more ion lenses during acquisition of each mass spectrum, a voltage value providing an optimum ion signal for each of the plurality of ion masses in the sample; and
storing data indicating the ion mass value and corresponding voltage value providing the optimum ion signal for each of the plurality of ion masses in the sample.

Therefore, there will be generated a set of results or signals for each measured ion mass (m/z) in the sample, with each result in the set being acquired with a different voltage applied to one (or more) ion lens in the mass spectrometer. Each result or signal from a particular ion in the set will have particular properties. One ion signal may be determined as being optimal (e.g., having the highest signal or s/n ratio). The value of the voltage for this result and this m/z is stored for future reference. Improved tuning of the mass spectrometer can be achieved across a wider mass range using this method.

The voltages applied to the one or more ion lenses may be DC voltages but may be a combination of DC voltages and AC/RF voltages. It is preferred, however, to use DC voltages only, thus using the ion lenses as electrostatic lenses. Such DC voltages may be stepwise static voltages, that is, voltages that are substantially constant over a period of time, for example a period of time during which a mass spectrum is acquired.

Optionally, the data indicating the ion mass values and corresponding voltage values for the optimum ion signal for that ion mass are stored as a lookup table. There are different ways to store the calibration results that may be retrieved and used to optimise the mass spectrometer before a particular measurement is made (i.e., of a sample with particular m/z ions).

Preferably, the method may further comprise the steps of:
fitting a curve to data of the ion mass and voltage applied to the one or more ion lenses when the optimum ion signal for each ion mass is acquired; and
storing parameters describing the fitted curve for each ion lens. The resultant or approximated curve allows the optimum ion lens voltage to be determined for the particular ion lens for ion masses (m/z) that are not contained within the calibration sample. Therefore, this reduces the time needed to calibrate the mass spectrometer as fewer analytes in the calibration sample are required. The curve fitting may be executed repeatedly for each ion lens as soon as results are available (collective stack approach, in case of strong interdependence between lenses), or are generated after all data have been collected (single lens approach, in case of weak interdependence between lenses).

Optionally, the curve may be a polynomial curve. Other functions may be used instead or in addition. Preferably, the polynomial may have an order in the range of 1 to 6.

Optionally, the one or more ion lenses may include an entry lens and an extraction lens of the mass spectrometer. Other voltages applied to other ion lenses may be optimised. The one of more lenses may be arranged downstream of the vacuum interface of the mass spectrometer. In some embodiments, the one of more lenses may be arranged downstream of the extraction lens.

Optionally, the method may further comprise the step of interpolating between ion masses of the sample to find voltage values providing optimum ion signals for ion masses not found in the sample (i.e., used in the calibration procedure). This can be a quick way to obtain other optimised (or close to optimum) voltages for different ions.

Optionally, the optimum ion signal may be the highest ion signal (that is, the ion signal having the highest intensity) obtained from each of the plurality of ion masses in the sample. Other criteria may be used to determine or define the optimum ion signal.

Optionally, each mass spectrum acquired from the mass analyser with the static voltage value applied to the one or more ion lenses may contain ion signals from all of the ion masses in the sample (optionally, also plasma signals may be used). The calibration method may still operate if a subset of ion masses is analysed but improves in accuracy with a higher number of ion masses being investigated. Ion signal variation with voltage may be smaller for some types of ion lenses. Therefore, a full set of results may not be necessary for these ion lenses.

Preferably, the voltage value may be varied multiple times to different values for a single ion lens and a separate mass spectrum may be acquired for each different voltage value. This process may be repeated at intervals or after a certain number of acquired mass spectra, to maintain calibration.

Optionally, the method may further comprise iterating the acquiring, determining and storing steps by varying the static voltage value applied to a different ion lens of the one or more ion lenses for each iteration. In one aspect, only the voltage applied to a single ion lens of the mass spectrometer is optimised for different ion masses. However, the process may be repeated or iterated until the voltages for two or more (or all) ion lenses has been optimised for each ion mass (single lens approach, in case of weak interdependence between lenses).

Optionally, the voltage value applied to all but one of the ion lenses are not varied during each iteration. Therefore, the calibration process during each iteration may focus on a single ion lens.

Alternatively, once the first set of voltages are found (for the first ion lens) then these identified voltages may be applied (for each ion mass in the sample) to the first ion lens during a subsequent calibration iteration for a second ion lens. Once the second set of voltages (for the second ion lens) is determined then the first set of voltages may be applied to the first ion lens and the second set of determined voltages may be applied to the second ion lens. The process may continue building up an optimised set of voltages for each ion lens in turn during subsequent iterations (collective stack approach, in case of strong interdependence between lenses).

Preferably, the stored data may indicate an identifier of the ion lens associated with the voltage value providing an optimum ion signal for each of the plurality of ion masses in the sample. Once all iterations are complete and the voltage set for each ion lens in the mass spectrometer are found then these may be stored for later retrieval when new samples are investigated by the mass spectrometer.

According to a second aspect, there is provided a method for operating a mass spectrometer having one or more ion lenses and a mass analyser, the method comprising the steps of:
varying a voltage applied to the one or more ion lenses (which may be optimised according to the above calibration method) as the mass analyser detects ion mass signals, wherein the value of voltage applied to the one or more (already optimised) ion lenses depends on a current ion mass being selected (e.g., detected) by the mass analyser. The voltage applied during the measurement of the one or more ion masses may be determined using any of the previously described calibration methods. Preferably, the voltage applied to the one or more ion lenses is a DC voltage but this is not essential. For example, the voltage may be DC, AC, RF, or any combination of these.

Preferably, the voltage may be varied step-wise. Therefore, the voltage may be allowed or preferably required to settle before each ion signal is acquired.

Optionally, the value of the voltage applied to the one or more ion lenses may be determined using a look-up table of ion masses and corresponding voltages. The value may also be determined by consulting or evaluating a fitted or interpolated function of optimum voltages dependent on ion mass for a particular ion lens. The function may be fitted against calibration values of optimised voltages determined using the described calibration method. The fitted curve may then provide an extrapolation of measured results so that an optimum voltage may be applied to an ion lens for a particular ion (m/z) that may not be included in the calibration sample.

In accordance with a third aspect, there is provided a computer program comprising program instructions that, when executed on a computer cause the computer to perform any previously described method.

In accordance with a fourth aspect, there is provided a computer-readable medium comprising instructions which, when executed by a computer, cause the computer to carry out the steps of any of the described methods.

In accordance with a fifth aspect, there is provided a mass spectrometer comprising:
one or more ion lenses;
a mass analyser, mass selection device and/or mass filter;
a detector, and
means adapted to execute the steps of any of the described methods.

Preferably, the mass spectrometer may further comprise a voltage or power supply connected to the one or more ion lenses. Preferably, the voltage or power supply is configured to supply DC, RF and/or AC (or any combination) voltages and can change voltage at high speed (e.g., settle to a new voltage within 50-100 μs or less).

Preferably, the mass spectrometer may be an inductively coupled plasma mass spectrometer (ICP-MS). Other mass spectrometers may be used.

The methods described above may be implemented as a computer program comprising program instructions to operate a computer. The computer program may be stored on a computer-readable medium, including a non-transitory computer-readable medium.

The computer system may include a processor or processors (e.g., local, virtual or cloud-based) such as a Central Processing Unit (CPU), and/or a single or a collection of Graphics Processing Units (GPUs). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a graph of applied DC voltage for an ion lens and ion signal intensity for different ions;

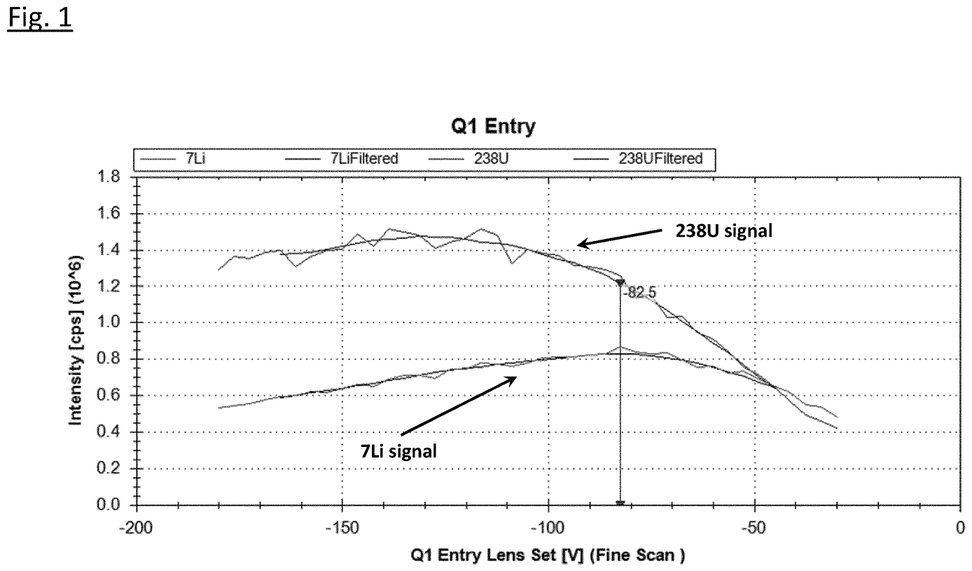

FIG. 2 shows a schematic diagram of a mass spectrometer having ion lenses, given by way of example only;

FIG. 3 shows a flowchart of an exemplary calibration method of the mass spectrometer of FIG. 2;

FIG. 4 shows a schematic diagram of a system including the mass spectrometer of FIG. 2; and

FIG. 5 shows a graph of results obtained from the calibration method of FIG. 3.

FIG. 6 shows simulation results of an ion optical lens stack.

It should be noted that the figures are illustrated for simplicity and are not necessarily drawn to scale. Like features are provided with the same reference numerals.

### DETAILED DESCRIPTION OF THE PREFERRED EMBODIMENTS

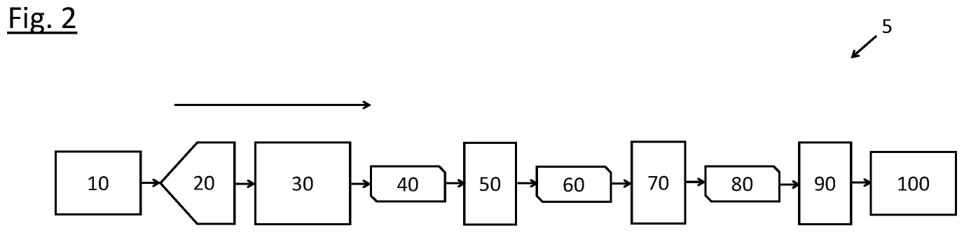

FIG. 2 shows a schematic diagram of a mass spectrometer 5 that may be calibrated and operated to obtain optimised mass spectra. An aberration correction or calibration method may be applied to the mass spectrometer 5, which may then be operated with calibration settings according to data obtained from the calibration method.

In this example implementation, the mass spectrometer 5 operates with ions moving in the direction (left to right) indicated by the horizontal arrows in this figure. However, the components may be arranged in any direction and oriented accordingly. An atmospheric plasma source 10 provides the ions. A vacuum interface 20 allows the pressure within the mass spectrometer 5 to be limited and to introduce a sample (preferably a calibration sample with a known composition) into the following mass analyser, which may comprise lens arrangements and multipole devices.

Ion extraction is achieved using a first lens stack (lens stack 1) 30. Preferably, the aberration correction or calibration method may be applied to the ion extraction and first lens stack (1) 30. However, this method can also be applied to any of the other ion lenses or lens stacks 50, 70 and/or 90. The other components of this example mass spectrometer 5 are: first multipole device (1) 40; second ion lens stack (2) 50; second multipole device (2) 60; third ion lens stack (3) 70; third multipole device (3) 80; fourth ion lens stack (4) 90; and detector unit 100. The aberration correction or calibration method may be carried out individually on any of the lens stacks 30, 50, 70, 90 or on any combination of lens stacks. As can be seen, the method applies to lenses or lens stacks downstream of the vacuum interface 20.

An optimisation process for the ion lenses preferably proceeds from the ion plasma source 10 to the detector 100 for each ion lens, i.e., left to right in the direction of the ion beam, as shown in FIG. 2. In this example, an ions lens or ion lens stack number (k) also increases in the direction of the ion beam.

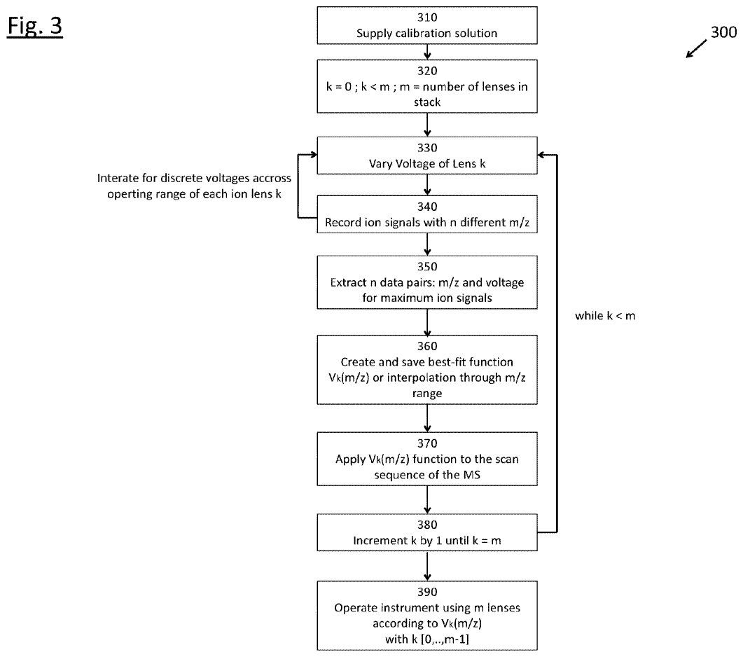

FIG. 3 shows a flowchart of an exemplary optimisation or calibration method 300. At step 310, a sample (e.g., a calibration sample) or solution is provided to the mass spectrometer 5. The calibration sample includes at least two different ion types providing different m/z signals from the mass spectrometer 5. The calibration sample contains ions of n different masses (that is, when the calibration sample is ionised, ions of n different masses are produced), where n can be any integer (e.g., n=2, 3, 4, 5, 6, 7, 8, 9, 10 or more).

In this example, the voltages of a plurality of ion lenses are determined, although the method will also provide calibration results for a single ion lens. As shown in FIG. 3, the method 300 iterates for each ion lens so that an optimised voltage that needs to be applied to each ion lens can be found in turn. The iterative nature of method 300 is indicated by steps 320, which sets a starting condition for the first ion lens or ion lens stack (k=0) and step 380, which increments number k until all ion lenses are considered. Each ion lens (having a lens number k) or ion lens stack is considered in turn for all ion lenses forming part of the mass spectrometer 5.

The first step in the iteration is step 330, where a voltage (preferably DC) applied to lens number k is varied to a different fixed voltage. At this fixed voltage, ion signals are recorded at step 340 for each ion (m/z) in the calibration sample, i.e., for all n m/z values. This forms a mass spectrum (i.e., ion signal intensities for all ions at a particular ion lens voltage). The method 300 iterates steps 330 and 340 until data are recorded for each ion signal (all n ions) at discrete fixed voltages across the operating range of each ion lens k. The voltage range may be divided evenly (for example, divided into 4, 5, 6, 7, 8, 9, 10 steps or above) with ion signals acquired for each ion (m/z) at every different static voltage. Alternatively, the voltage range (which may be different for each ion lens) may not be divided evenly and more (or all) ion signals may be recorded in particular voltage ranges applied to the ion lenses (e.g., where the ion lenses have improved performance). When the calibration method is repeated then finer or smaller voltage steps (or continuous changes in voltage) may be used at or around the previously determined optimum voltage for a particular ion lens. This can fine tune the calibration.

Once all of the ion signal data have been acquired for each ion mass and voltage for a particular ion lens, then at step 350 the voltage that was applied to the ion lens k that produced the optimal ion signal (e.g., the highest ion signal intensity) for each ion mass (m/z) is determined and recorded. This may be stored as a data pair, i.e., m/z and voltage. Therefore, each ion lens individually (or each ion lens stack collectively) may have a stored set of m/z—voltage pairs. With ion lens k having an applied voltage at one of these values, the corresponding ion signal will be the optimum ion signal for a particular ion (m/z).

The calibration sample does not need to contain ions which provide every m/z that the mass spectrometer can acquire. Preferably, the calibration sample may contain defined ion types (m/z) across a suitable range or the entire range of the device. In order to determine an optimum ion lens voltage for other m/z ion signals interpolation may be used against the acquired data. This may be further enhanced by curve fitting a function Vₖ(m/z) through the m/z range at step 360 resulting in a best-fit function. This best-fit function may be used to generate values across the m/z range of the mass spectrometer at step 370 so that any m/z ion signal can be optimally measured with an ion lens provided with an optimal voltage, even though the calibration sample does not contain all possible ions (m/z).

As long as there is another ion lens to be calibrated after k is incremented in step 380, then the next ion lens with number k+1 will be calibrated. When the different voltages are set to lens k+1 for the calibration method according to step 330, all ion lenses with numbers k and below may already operate by using their own calibration function or lookup table that have been already been determined. Therefore, an optimised voltage will be applied to each previously calibrated ion lens for each ion mass in the sample, during the calibration of a later or subsequent ion lens. This is achieved by applying the Vₖ(m/z) function at step 370 using calibration data gained during previous iterations. Every additional calibrated ion lens will therefore further improve the corrections that have already been put in place. Ideally, the relative voltage corrections become smaller as subsequent ion lens voltages are optimised (i.e., the higher the number k becomes). However, this is not a requirement for such a correction method to work properly, and it will individually depend on the selection of ion lenses that are included in the optimisation scheme. Not all ion lenses in a system need to be optimised in this way.

Once k=m is reached, then the calibration method may complete, or it may be started again, for a second, third, or higher-level fine improvement run. Preferably, the correction functions determined after the first fully accomplished calibration run are saved if they are sufficient for the aberration correction of the ion lens stack. This may be determined using predefined thresholds or other criteria, for example.

Once all ion lenses are calibrated in this way, i.e., data have been collected enabling each ion lens to be operated at an optimum voltage providing an optimum ion signal for all m/z, then the mass spectrometer 5 may be operated with each ion lens voltage being set to its optimum voltage during data acquisition for each ion species (step 390). The voltages applied to each ion lens may be varied step-wise according to the calibration data or Vₖ(m/z) function.

In this example, an optimised ion signal corresponds with a maximum ion signal, but different optimisation criteria may be used. For example, an optimised ion signal may have the lowest signal to noise ratio or other transmission condition.

Optimisation of the mass spectrometer means that a transmission condition is fulfilled for every ion lens. This may be a maximum condition (e.g., signal recorded at a detector of the mass spectrometer 5) for an analyte, but it may also be a minimum condition for an unwanted ion signal, or a ratio of both, as an example of a complex optimisation condition. Other complex conditions can for example, include additional side conditions. The method 300 may be operated using a computer or computer system or within a processor of the mass spectrometer 5.

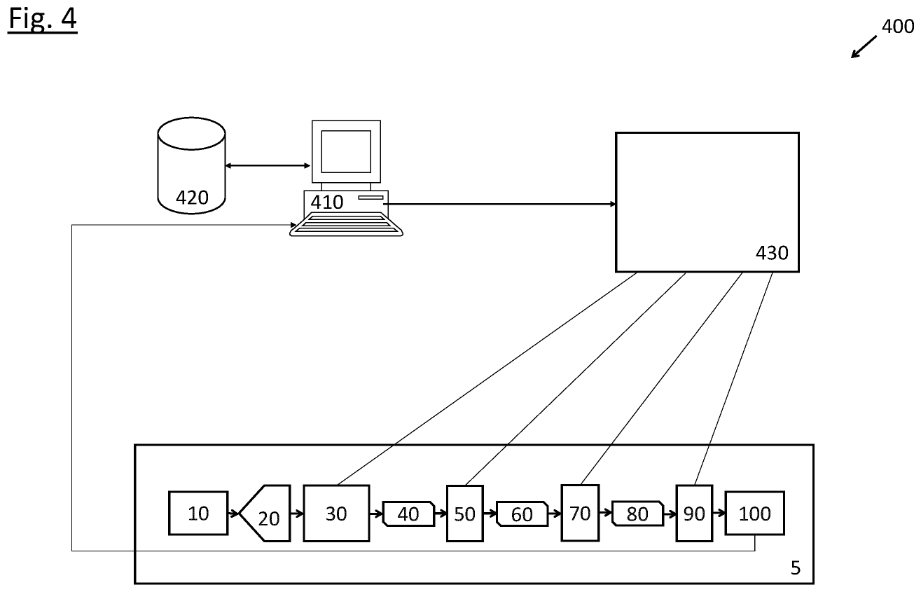

FIG. 4 shows a schematic diagram of a system 400 for calibrating and operating the mass spectrometer 5. A computer 410 controls and manages the calibration method 300, and also collects data from the mass spectrometer (both when calibrating and collecting data from samples). Calibration data (voltage values, ion lens references, mass spectra, etc.) are stored in database 420. Power supply 430 provides any DC voltages (and any additional AC or RF signals) to the ion lenses 30, 50, 70, 90 of the mass spectrometer 5. The power supply 430 is also controlled by the computer 410 and/or may have a separate control circuit.

The detector 100 of the mass spectrometer provides data that are processed by the computer 410 and stored in database 420. The computer 410 and database 420 may be local to the mass spectrometer 5 or remote from it and accessible over a network, for example. The computer 410 and/or database 420 may be located within the same housing or be a part of the mass spectrometer 5, for example.

Once the calibration or optimisation process has been carried out using a sample of known ions (i.e., a calibration sample), the mass spectrometer 5 may be used to acquire data from a sample containing an analyte (e.g., a sample of unknown composition). For each data acquisition task, the mass spectrometer 5 (or a computer controlling the mass spectrometer 5) may receive an extended set of parameters, which includes the optimum lens voltages (as determined during the calibration method 300) for each ion lens and m/z combination. The ion lenses are supplied with voltages using the voltage supply 430 with fast-switching capability. Therefore, the best (optimum) ion lens voltages are applied to each ion lens when a particular ion mass (m/z) is measured by the mass spectrometer 5 (or when the mass spectrometer 5 attempts to detect ions of a particular mass). The ion transfer optics, any reaction cell and analyser (which includes multipole devices) are stabilised simultaneously within the settling time after a mass jump (change of m/z detection by the mass analyser of the mass spectrometer 5).

For single collector mass spectrometers, the mass analyser (e.g., any one or more of the multipole devices 40, 60, 80) scans through the m/z range by shifting the mass window as a function of time. The ion lens voltages are also varied so that the transfer optics receive optimised voltage settings corresponding to the instantaneous m/z ratio that is set by the mass analyser. Preferably, any DC voltages applied to the ion lenses change step-wise and settle before each signal is acquired for each ion.

This typically requires a fast-switching high voltage (HV) ion lens power supply 430 and an extended tuning algorithm, which determines a function Vₖ(m/z), rather than only a single lens voltage. (The indicator k indicates different ion lenses that make up the transfer optics, as described previously). The settling time that is required for the HV lens power (i.e., voltage) supply 430 needs to be on the same scale as or lower than the analyser settling time. This is typically in the range between 100 μs and 2 ms. Within this time span, the new lens voltages are preferably stabilised.

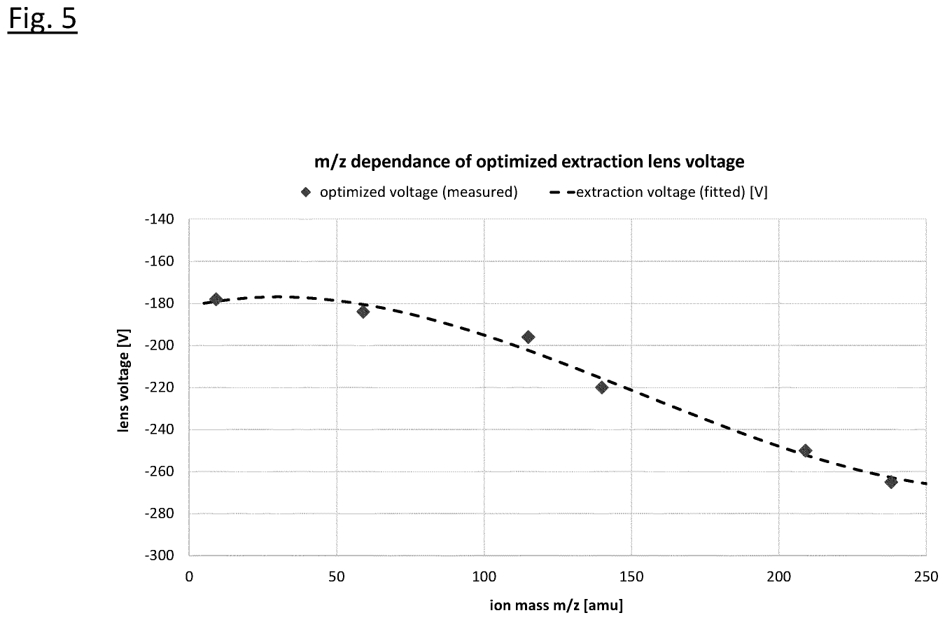

FIG. 5 shows a graph indicating the m/z-dependence of the optimum lens voltage for a typical ion lens system The dotted line represents an interpolation function Vₖ(m/z) that was fitted on several (in the present example six) voltage-m/z data pairs. Thus, the interpolation function Vₖ(m/z) provides a voltage that depends on m/z, according to the calibration data (i.e., as a signal is acquired for each m/z in the sample under investigation). Additional settling time may be required when a time lag of the signal is to be expected, as in the case of a reaction cell or an ion mobility device following the transfer optics. This may be achieved by suitable configuration of a management program operating on the computer 410 and/or mass spectrometer 5.

In an example implementation, an inductively coupled plasma mass spectrometer (ICP-MS) may be used. The reaction cell of such an ICP-MS may comprise a multipole device, such as a quadrupole or hexapole device. Therefore, a provided RF signal may already be controlled to be dependent on m/z, and corresponding settling times (i.e., programmed waits) may already be in place.

In the iCAP Qnova™ or similar system, it may be required that the control software determines optimum lens voltages for every corrected ion lens in an extended autotune process. With this enhanced procedure, the structure of the existing autotune procedure is maintained, but now includes a sufficient number n of different ion species and measurements of their signals simultaneously. Therefore, the optimum voltage for each species may be determined, and an inter- and extrapolation can take place across the complete elemental mass range.

The following describes an example optimisation or calibration procedure to reduce aberration by applying corrective ion lens supply voltages to the system 400. The fit function that is used in this example is a 4th order polynomial but any order may be used.

The sample used for this calibration process requires an elemental mass range with a sufficient number of ion species n, preferably between 6 and 8, with roughly equal spacing between their m/z values. An example list of eight elemental tuning analytes is: 9Be, 45Sc, 59Co, 89Y, 115 In, 165Ho, 209Be, 238U. Any combination of these or other ions may be used. For a curve of the 4th order, five ion masses may be sufficient. Even, for a curve of the 1st order using only two ion masses, there may be some advantage in using the method.

The interpolation is preferably achieved using a least-squares method with a fitting polynomial of order m (m=1 . . . 6) to the data. The selected curve fitting procedure may depend on the specific ion-optical lens system and the ion lens under consideration (number k). Therefore, fitting the calibration data for a particular ion lens may use a different function to another ion lens in the same mass spectrometer. Another option is to use local cubic splines but any mathematical function or look-up table may be used. However, the number of necessary parameters describing the fitted curve may vary. In case of spline fits, the number of parameters may be 4*n*m, while polynomial fitting only requires (p+1)*m different parameters, if polynomial orders are identical to p for all lenses k.

The parameters that describe the mathematical functions of the inter- and extrapolation may be stored together with all other tuning parameters. When an acquisition task is started, all required mass-dependent ion lens voltages are calculated or retrieved in the case of a look-up table, and sent to the mass spectrometer 5, the control computer 410 or other management circuitry. This tuned set of data is stored within database 420 or other data store and describes the dynamic operation of the lens stack. These data provide documentation on all possible instrument states during acquisition, which may also satisfy applicable compliance requirements.

In existing tuning techniques, only static voltages are supplied to the transfer ion optics and so this represents a compromise solution across different ion masses (m/z). Improvements are found when dynamic voltage control is carried out during an acquisition period. Between acquisition periods, voltages applied to each ion lens (and so their refraction power) are changed so that every ion lens achieves an optimum transmission of the next ion signal (m/z) to be measured. This may be compared to adaptive focussing within an optical lens system. The method 300 may correct ion energy-dependent aberrations of axial systems as well as correct inaccurate focusing in non-axial, point-to-point imaging systems like beam deflection devices.

A property of the system 400 and method 300 is that there is not only one corrected ion lens, but a plurality of successive ion optical elements is each contributing to the correction. The correction function for one specific element is determined while the correction functions of all other elements located upstream are already active. This leads to successive improvements in ion lens error correction, which increases with the number of corrective elements. Each ion lens element can correct any residual focus errors that were left over by the upstream section of the correcting lens stack. During the calibration process, once an upstream (closer to the ion source) ion lens is individually calibrated, then the optimum ion lens voltage may be applied to that ion lens (for each subsequent m/z signal reading), whilst the next downstream ion lens has its set of mass spectra collected (i.e., with a static different voltage applied across the entire mass spectrum for all analytes in the calibration sample, but different for every single measured mass spectrum). The data for that second ion lens may then be analysed and fitted to determine its own set of optimum voltages/m/z values. Then the next downstream ion lens may be calibrated with the two upstream ion lenses receiving their optimum lens voltages. The process may continue until data for all ion lenses are obtained and all ion lenses can be operated under optimum conditions (i.e., voltages) for all applicable ions.

The described successive correction of several elements of an ion-optical lens stack or a series of ion-optical lens stacks minimises the overall energy error and therefore resembles the achromatic correction of a light-optical lens design.

For a particular ion lens in the system 400, a set of results (e.g., providing a maximum ion signal) may be determined. For example, this may be (m/z: Voltage):

| | |
|---|---|
| 7 | −72 |
| 59 | −103 |
| 115 | −140 |
| 140 | −141 |
| 209 | −150 |
| 238 | −155 |

Such results are similar to those shown in the graph of FIG. 5 and may be parameterised and fitted to obtain fitting parameters (order: value)

| | |
|---|---|
| P0 | −46.5 |
| P1 | 1.32e−1 |
| P2 | −6.79e−3 |
| P3 | 7.71e−6 |
| P4 | 4.29e−8 |

The curve that is described by such parameters, i.e., voltage (y-axis) against m/z (x-axis) may be used to determine the optimum voltage (for the particular ion lens) for any m/z even though only six ions were required in the calibration sample. This may be achieved by reading off the voltage values from the curve (or by deriving the voltage values from the interpolation function using a computer).

The described adaptive focusing system improves instrument performance.
1. The optimum transmission can be achieved for every m/z even in the presence of energy-dependent focus shifts.
2. The system 400 and method 300 provide a more stable operating point, because at optimum transmission, the transmission change with ion lens voltage is minimal (by definition). Voltage settings on the flat top of the transmission function may be more robust than those which are partially sitting on the flank.

The system 400 may be set up to enable a mass-dependent transmission by creating a controlled focus/defocus as a function of m/z. Updating the parameter sets using idle-time acquisitions to recalibrate the system may also be carried out.

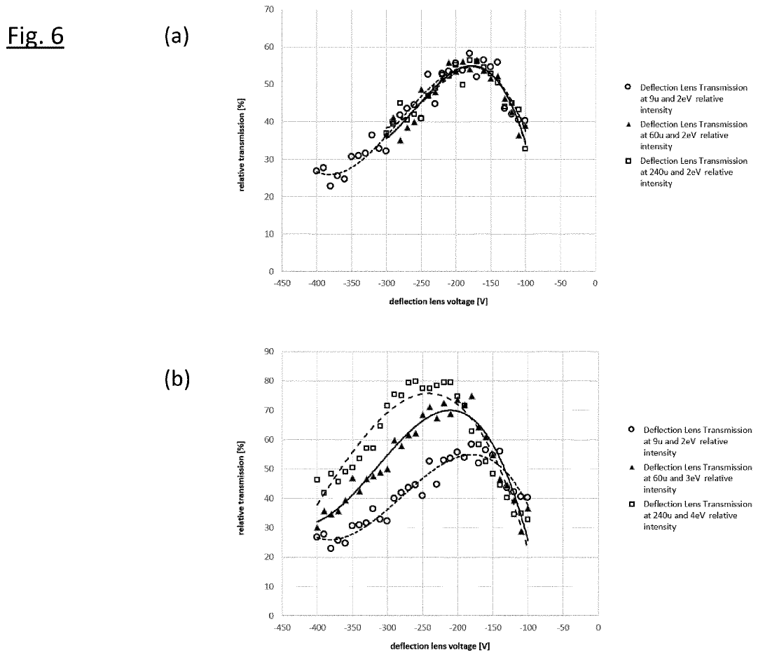

FIG. 6 shows simulation results of an ion-optical lens stack used in an ICP-MS system. The ion transmission is plotted as a function of one of the lens voltages that is part of the transfer optics. In case of identical ion energies for all m/z, as shown in FIG. 6(a), the transmission curves are practically identical, and are substantially independent of the m/z (mass/charge) ratio. In other words, if the beam were sufficiently monoenergetic, there would be no need for any correction in these transfer optics. In reality, there will be small differences in the average ion energies, which depend on the ion's m/z. FIG. 6(b) shows the impact on the transmission curves when only 1 or 2 eV of energy are added. The plots show that in this case, 2 eV is enough to shift the lens voltage that yields best transmission by nearly 100 V to the negative.

As used throughout, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element may instead be termed a “second” element and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

It is also to be understood that, for any given component or embodiment described throughout, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

Unless otherwise described, all technical and scientific terms used throughout have a meaning as is commonly understood by one of ordinary skill in the art to which the various embodiments described herein belongs.

As will be appreciated by the skilled person, details of the above embodiment may be varied without departing from the scope of the present invention, as defined by the appended claims.

For example, different types of mass spectrometers may be used. The mass spectrometer may contain any different number of ion lenses. Any or all of the ion lenses may have DC voltages applied or varied. One or more of the ion lenses may have a static DC voltage applied for the whole range of ion masses provided that at least one ion lens has a DC voltage applied that varies with ion mass (m/z).

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method for calibrating a mass spectrometer having one or more ion lenses and a mass analyser, the method comprising:
acquiring from the mass analyser a plurality of mass spectra from a sample, the sample comprising a plurality of ion masses, wherein a voltage value applied to the one or more ion lenses is static while each mass spectrum is obtained and the voltage value is varied between different mass spectra;
determining from the plurality of mass spectra and corresponding voltage applied to the one or more ion lenses during acquisition of each mass spectrum, a voltage value providing an optimum ion signal for each of the plurality of ion masses in the sample; and
storing data indicating the ion mass value and corresponding voltage value providing the optimum ion signal for each of the plurality of ion masses in the sample.

2. The method of claim 1, wherein data indicating the ion mass values and corresponding voltage values for the optimum ion signal for that ion mass are stored as a lookup table.

3. The method of claim 1, further comprising:
fitting a curve to data of the ion mass and voltage applied to the one or more ion lenses when the optimum ion signal for each ion mass is acquired; and
storing parameters describing the fitted curve for each ion lens.

4. The method of claim 3, wherein the curve is a polynomial curve.

5. The method of claim 4, wherein the polynomial has an order in a range of 1 to 4.

6. The method of claim 1, wherein the one or more ion lenses include an entry lens and an extraction lens of the mass spectrometer.

7. The method of claim 1, further comprising the step of interpolating between ion masses of the sample to find voltage values providing optimum ion signals for ion masses not found in the sample.

8. The method of claim 1, wherein the optimum ion signal is a highest ion signal obtained from each of the plurality of ion masses in the sample.

9. The method of claim 1, wherein each mass spectrum acquired from the mass analyser with the static voltage value applied to the one or more ion lenses contains ion signals from all of the ion masses in the sample.

10. The method of claim 1, wherein the voltage value is varied multiple times to different values for a single ion lens and a separate mass spectrum is acquired for each different voltage value.

11. The method of claim 1, further comprising iterating the acquiring, determining and storing steps by varying the static voltage value applied to a different ion lens of the one or more ion lenses for each iteration.

12. The method of claim 11, wherein the voltage value applied to all but one of the ion lenses are not varied during each iteration.

13. The method of claim 11, wherein the stored data indicates an identifier of an ion lens associated with the voltage value providing an optimum ion signal for each of the plurality of ion masses in the sample.

14. A method for operating a mass spectrometer having one or more ion lenses and a mass analyser, the method comprising:
varying a voltage applied to the one or more ion lenses as the mass analyser detects ion mass signals, wherein a value of voltage applied to the one or more ion lenses depends on a current ion mass being selected by the mass analyser.

15. The method of claim 14, wherein the voltage is varied step-wise.

16. The method of claim 14, wherein the value of the voltage applied to the one or more ion lenses is determined using a look-up table of ion masses and corresponding DC voltages.

17. The method of claim 15, wherein the value of the voltage applied to the one or more ion lenses is determined using a look-up table of ion masses and corresponding DC voltages.

18. A non-transitory computer-readable medium comprising instructions which, when executed by a computer, cause the computer to carry out a method comprising:
acquiring from a mass analyser a plurality of mass spectra from a sample, the sample comprising a plurality of ion masses, wherein a voltage value applied to one or more ion lenses is static while each mass spectrum is obtained and the voltage value is varied between different mass spectra;
determining from the plurality of mass spectra and corresponding voltage applied to one or more ion lenses during acquisition of each mass spectrum, a voltage value providing an optimum ion signal for each of the plurality of ion masses in the sample; and
storing data indicating the ion mass value and corresponding voltage value providing the optimum ion signal for each of the plurality of ion masses in the sample.

19. A mass spectrometer comprising:
one or more ion lenses;
a mass analyser, mass selection device or mass filter;
a detector; and
means adapted to execute a method that includes:
acquiring from the mass analyser a plurality of mass spectra from a sample, the sample comprising a plurality of ion masses, wherein a voltage value applied to the one or more ion lenses is static while each mass spectrum is obtained and the voltage value is varied between different mass spectra;
determining from the plurality of mass spectra and corresponding voltage applied to the one or more ion lenses during acquisition of each mass spectrum, a voltage value providing an optimum ion signal for each of the plurality of ion masses in the sample; and
storing data indicating the ion mass value and corresponding voltage value providing the optimum ion signal for each of the plurality of ion masses in the sample.

20. The mass spectrometer of claim 19, further comprising a voltage supply connected to the one or more ion lenses.

21. The mass spectrometer of claim 19, wherein the mass spectrometer is an inductively coupled plasma mass spectrometer, ICP-MS.
